(19) United States
(12) Patent Application Publication
(10) Pub. No.: US 2024/0399428 A1
(43) Pub. Date: Dec. 5, 2024

(54) CLEANING MECHANISM AND UNDERDRAIN FOR MEDIA VESSEL AND METHOD OF CLEANING

(71) Applicant: BL Technologies, Inc., Minnetonka, MN (US)

(72) Inventors: Michael DOUPE, Belwood (CA); Nishith VORA, Trevose, PA (US); Chris SCOTT, Trevose, PA (US)

(21) Appl. No.: 18/695,715

(22) PCT Filed: Oct. 4, 2022
(86) PCT No.: PCT/US2022/045700

§ 371 Date: Mar. 26, 2024

Related U.S. Application Data
(60) Provisional application No. 63/253,863, filed on Oct. 8, 2021.
(60) Provisional application No. 63/306,802, filed on Feb. 4, 2022.

(51) Int. Cl. B08B 9/093; B08B 9/08

(52) U.S. Cl. CPC B08B 9/0936; B08B 9/0813

(57) ABSTRACT

An underdrain system for a media pressure vessel has a set of removable pipe sections located between an external header and the bottom of a vessel. Septa extend upwards from the removable pipe sections into the vessel. The header is attached to the bottoms of the removable pipe sections. To clean the vessel, the pipe sections are removed. While a pipe section is removed, its associated septum is removed so that solids can be removed from the annulus between the septum and the vessel. In this way, media can be cleaned from the annuli without moving the external header or entering the vessel. A cleaning mechanism includes an elongated member with a spray nozzle that may be moved within the vessel. The cleaning mechanism may be used to removed media adhered to the walls of the vessel, for example while the septa are removed.

### RELATED APPLICATIONS

This application claims the benefit of, and priority to, U.S. Patent Application Ser. No. 63/253,863, filed Oct. 8, 2021, and U.S. Patent Application Ser. No. 63/306,802, filed Feb. 4, 2022, which are incorporated herein by reference.

### FIELD

This specification relates to media vessels, as used for example for water treatment, and to methods of cleaning them.

### BACKGROUND

Some water treatment methods involve flowing the water to be treated through a media bed. The medium used in the bed may be, for example, a filtration material, an adsorptive material, or an ion exchange material. In some methods, the media is contained in a pressure vessel. The vessel is often made of steel and supported on the ground through a set of legs. Many vessels are rated for a pressure of 125 psi at 150° F. (860 kPa at 65° C.), although other ratings are possible. Water typically enters the top of the vessel and flows downwards through the media. Treated water is collected in an underdrain system located in the bottom of the vessel.

A false-bottom underdrain system has many (i.e. 80 to 300) intake nozzles mounted on a false-bottom cone or flat plate welded to the inside circumference of the vessel. When the nozzles or the cone require maintenance, a person must enter the vessel to perform the maintenance. This requires following various safety procedures for confined-space entry (CSE).

Alternatively, an external header underdrain system may be used. The external header is located below and outside of the pressure vessel. Several (i.e. 8) septa (alternatively called strainers or screens) extend upwards into the vessel. The septa are in fluid communication with ports that extend downwards from the bottom of the vessel. The header is connected to the bottom of the ports. When in use, the header collects treated water flowing through the septa and the ports. When the septa require maintenance, the external header is unbolted and lowered away from the bottom of the vessel or a confined-space entry is made to access the septa from inside the vessel. A pressure vessel with an external header underdrain system is shown, for example, in U.S. Pat. No. 10,981,802, entitled Water Treatment Systems and Methods of Treating Water.

As water passes through the media, its ability to treat the water deteriorates. In particular, adsorptive media such as granular activated carbon (GAC) becomes saturated/exhausted and is no longer able to absorb contaminants in the water. Ion exchange materials, typically in the form of resin beads, have a limited number of ions that can be exchanged. In some cases, a medium may be regenerated for a limited number of times while in the vessel, but the media eventually needs to be removed from the vessel in order to be regenerated outside of the vessel or replaced. For this purpose, a media outlet is provided at the bottom of the vessel and a media fill port is provided near the top of the vessel. Water added to the tank can fluidize the media allowing it to flow as slurry from the vessel. Similarly, new media may be added as slurry into the vessel through the media fill port.

While the vessel is empty, water is released from a spray nozzle at the top of the tank to rinse and wash the interior of the vessel. The industry standard design is a nozzle located in the center of the top of the tank. This central nozzle sprays water in all directions, i.e. through an angular range of 360 degrees, at the same time. Alternatively, a worker can enter the vessel to spray water from a handheld nozzle. However, entering the vessel can be dangerous and thus requires additional labor and safety apparatus.

### INTRODUCTION

The following discussion is intended to introduce the reader to the invention and the detailed description of embodiments to follow, but not to limit or define any claimed invention.

The process of replacing media from a pressure vessel, which may occur every 1-3 months, leaves trace amounts of exhausted media or other contaminated solids lodged in areas around vessel underdrain components. In particular, in external header underdrain systems there is an annulus between the inside of each port and its associated septum where spent media can become trapped. Although the volume of this annulus is small, when treating water to very low concentrations, enough exhausted media can be retained in these areas to cause water filtered after the media change to fail to meet treatment standards. For example, when treating water to remove poly- and per-fluoroalkyl substances (PFAS) the treated water must meet standards specified in parts per trillion or nanograms per liter. When using an ion exchange medium, almost every single resin bead needs to be removed from the vessel with each media replacement. If the water fails to meet treatment standards, the media must be replaced again at a cost of tens of thousands of dollars in new resin beads for a typical, i.e. 7-12′ (2.1-3.7 m) diameter pressure vessel.

Removing media from the annuli of a conventional pressure vessel requires either a confined space entry (CSE) to remove the material from within the vessel, or removal of the septa from outside the vessel. CSE is undesirable since it involves risk of asphyxiation, having a rescue crew on standby, setting up a retrieval apparatus and extra plant personnel. But alternatively, typical commercially available external header underdrain systems are designed for removal of the underdrain system only very infrequently, not to remove the septa with every media replacement. Removing the external header is a significant job requiring multiple people and lifting equipment to support and lower the header and later lift it back into place. Movement of the header may also be complicated by additional pipes near or connected to the header and other restrictions limiting access

An underdrain system is described herein having removable pipe sections between an external header and a vessel, such as a pressure vessel for a media bed. Optionally, the tops of the pipe sections are attached to short fittings such as flange pads on the bottom of the vessel. The pipe sections can be removed, for example one by one, without moving the external header. As each pipe section is removed, its associated septum may be removed from the vessel by moving the septum through the space previously occupied by the pipe section. An annulus around the septum can then be cleaned from the outside of the pressure vessel. In this way, the annuli can be cleaned without entering the pressure vessel and without removing the header from the pressure vessel.

This specification describes an underdrain system having a set of removable pipe sections located between an external header and the bottom of a vessel. The tops of the removable pipe sections, optionally called spools herein, are attached to the bottom of the vessel. Optionally, short fittings such as flange pads may be attached to the bottom of the vessel for attaching the tops of the pipe sections. Optionally, the tops of the pipe sections may be located within 5 cm of, or even above, the bottom of the vessel. Septa extend upwards into the vessel and are in fluid communication with the pipe sections. The header is attached to the bottoms of the removable pipe sections. Optionally, the header is also attached to the bottom of the vessel independently of the removable pipe sections. Connections between the vessel, the septa, the removable pipe sections and the header are configured such that each pipe section may be removed, optionally without removing other pipe sections, for example by moving a pipe section horizontally. These elements are further configured such that a septum may be removed from the vessel when its associated pipe section has been removed from the vessel and the header. In some examples, the removable pipe sections are vertical and attachments between the removable pipe sections and the tank and header are made by way of horizontal flanges. In some examples a septa has a flange inserted between an upper flange of a pipe section and a flange attached to the vessel. In some examples, each removable pipe section is longer than its associated septa. In some examples, a removable pipe section includes or is connected to a flexible section.

This specification describes a method of cleaning a media vessel. Media is removed from the vessel through a media drain. One or more pipe sections are removed from between an external header and the vessel while the header remains otherwise attached to the vessel. One or more septa associated with the removed pipe sections are removed from the vessel. Additional solids, for example in annuli around the one or more septa, are removed from the vessel. The removed septa and pipe sections are replaced. Optionally, one or more pipe sections that remain attached to the vessel or independent attachments support the header while one or more other pipe sections are removed from the header and the vessel.

The system and method described herein allow the septa to be removed without lowering the header. In some examples, a pipe section is small enough to be handled by a single person without lifting or jacking equipment. The header may remain attached to the vessel throughout the cleaning procedure, and other outlet pipes attached to the header do not need to be disturbed.

The process of replacing media from a pressure vessel also leaves trace amounts of exhausted media or other contaminated solids adhered to the walls of the vessel. The spray nozzle used in conventional vessels sprays water in all directions at the same time from a single stationary nozzle located at the top of the vessel. The form of the spray is a result of the initial placement of the nozzle, the orientation of its parts, and the pressure of the water fed into it. There is no ability to adjust, move or direct the cleaning spray. Even after using the spray, some exhausted media or other residue may remain on the walls of the vessel.

This specification describes a mechanism for cleaning a vessel. The cleaning mechanism includes an elongated member that can be used to move a spray nozzle within the vessel. The spray nozzle can be moved in one or more of horizontal, vertical and rotational movements. In some examples, the elongated member includes a section of pipe. The elongated member is optionally longer than the depth of the vessel. In some examples, the cleaning mechanism also includes a fitting that may be selectively fitted to the vessel where the cleaning mechanism is inserted into the vessel. The fitting may be attached to a flange at the top of the vessel, for example a flange ordinarily used to attach a conventional wash nozzle. In some examples, the cleaning mechanism includes a set of spray nozzles that can be selectively attached to the elongated member.

The specification also describes a method of cleaning a vessel. While most of media has been removed from the vessel, a cleaning mechanism as described above is inserted into the vessel, typically through an opening at the top of the vessel. In some examples, a conventional wash nozzle, or a plug that replaces the conventional wash nozzle, is removed from the opening to admit the cleaning mechanism. In some examples, a fitting is attached to the opening to provide a bearing or aligning surface for the cleaning mechanism. Water is sprayed through the cleaning mechanism while the cleaning mechanism is moving, or while the cleaning mechanism has been placed into one of multiple positions. This cleaning may be performed in combination with removing septa from the vessel as described above. In this way, media washed from the walls of the vessel flows to the bottom of the vessel and is removed through openings created by removing the septa.

### BRIEF DESCRIPTION OF THE FIGURES

FIG. 1 is an isometric view of a pressure vessel for water treatment using a media bed with an external header underdrain system.

FIG. 2 is a side view of the pressure vessel of FIG. 1.

FIG. 3 is a front view of the pressure vessel of FIG. 1.

FIG. 4 is an isometric view of a header and spools (i.e. removable pipe sections) of the underdrain system of FIG. 1.

FIG. 5 is a top view of the header and spools of FIG. 4.

FIG. 6 is a side view of the header and spools of FIG. 5.

FIG. 7 is a side view of a septum of the underdrain system of FIG. 1.

FIG. 8 is an isometric view of the septum of FIG. 7.

FIG. 9 is an enlarged view of part of the vessel of FIG. 1 showing a flange pad and spool removed from the flange pad.

FIG. 10 shows steps in cleaning a vessel of FIG. 1.

FIG. 11 shows and an alternative removable pipe section.

FIG. 12 shows another alternative removable pipe section.

FIG. 13 shows a cleaning mechanism.

### DETAILED DESCRIPTION

A detailed description of one or more examples or embodiments will be described below to assist in describing the invention and to further enable the reader to make and use the invention. In this detailed description, the invention will be described as used with an otherwise conventional pressure vessel of the type used to hold a water treatment media, for example granular activated carbon or ion exchange resin beads. However, the invention may be applied to other water treatment equipment having a drain system near the bottom of the vessel. A particular example or embodiment might not be within every claimed invention.

A conventional pressure vessel with an underdrain system including an external header has a number, for example 8, of ports attached (i.e. welded) to the bottom of the tank. The ports may be located in a circle around a central media outlet, which is used to remove media from the vessel. The ports are typically made of a section of pipe about 6-12″ (15-30 cm) long. A flange is welded on one end of the port and the other end of the port is welded to the tank. Septa in fluid communication with the ports extend upwards into the tank. An external ring header is then attached (i.e. bolted) to flanges of the ports.

In a vessel described herein, removable pipe sections are added between the vessel and the ring header. These pipe sections (optionally called spools in some examples) facilitate removal of the septa for cleaning or inspection, or for cleaning of the annuli around them, without the need to remove the ring header. The pipe sections may be, for example, 6-18″ (15-45 cm) long. This may improve one or more of the speed, ease, and safety of cleaning the septa or annuli during maintenance or when replacing the media in the vessel. In some examples the removable pipe sections are rigid assemblies. For example a removable pipe section may be made up of a length of steel pipe with flanges welded onto each end of it. In other examples, a removable pipe section may be made in the form of a flexible connector or include a rigid section and one or more flexible connectors. A flexible connector, alternatively called an expansion joint, includes a flexible section that allows for an axial misalignment between an upper end and a lower end of the flexible connector, or an axial expansion of the flexible connector, or both. When the removable pipe sections include a flexible section, independent attachments may be added between the header and the vessel.

Optionally, the ports of a conventional vessel are also replaced with tangential flange pads (alternatively called flange pads or studding outlets). Alternatively, short ports may be used but the flange pads are typically the shortest form of fitting to a curved vessel bottom having a flange available. A flange pad may have a length, measured on its longest side, of 4″ (10 cm) or less. The bottom of the flange pad, or a short port or other fitting attached to the vessel, may be less than 5 cm below the lowest point, excluding any attached fittings, of the bottom of the vessel (typically found at the center of the bottom of the vessel), and optionally may be above the lowest point, excluding any attached fittings, of the bottom of the vessel. The top of the flange pad may be welded over a hole in the vessel. The bottom of the flange pad has a set of threaded holes. A septum with a flange on its lower end is inserted into the vessel through the flange pad. A removable pipe section is then bolted to the flange pad by way of a flange on the top of the pipe section. The flange of the septum is secured between the flange of the pipe section and the flange pad. The use of flange pads, or other short flanges, reduces the height of the vessel directly, and also by way of reducing the length of the septa which in turn allows the removable pipe sections to be short. However, conventional ports could alternatively be used, for example because they are readily available to the manufacture or already fitted to an existing vessel that is being adapted for use with the removable pipe sections. When using conventional ports, the vessel legs may need to be lengthened. Optionally, if conventional ports are used, they may be modified or originally fabricated to be not more than 20 cm long.

Optionally, the flange pad may have one or more ports through its sidewall. A port may be drilled through the flange pad and tapped to receive a pipe fitting. The port may be used to flush or drain an annulus between the septa and the flange before or without removing the septum. In this way, removal of the septum to clean the annulus may be delayed or avoided.

The ring header is attached to the bottom of the removable pipe sections, for example by way of horizontal flanges. Unbolting a pipe section from the flange pad and a flange on the ring header allows the pipe section to be removed by sliding it sideways. The septum can then be pulled downwards into the space previously occupied by the pipe sections. This allows an annulus between the septum and the flange pad to be cleaned from outside of the vessel. Optionally, the septum may be shorter than the pipe section. The septum can then be moved sideways to completely remove it from the tank to allow for better access to the annulus or to clean, inspect or replace the septum.

While one or more pipe sections are removed, the ring header remains attached to the vessel by other pipe sections that have not been removed, by optional independent attachment members, such as struts or U-bolts, between the ring header and the vessel, or both. One, or more than one, pipe section can be removed at a time. Optionally, flexible connectors, for example of the type having a flexible section between two flanges, may be inserted between the removable pipe sections and the header or the vessel or both the header and the vessel. In some examples, the flexible connectors may be METRASPHERE™ flexible connectors sold by Metraflex Quality Products. One or more flexible connectors may be removed with a rigid removable pipe section (and be considered part of the removable pipe section) or remain attached to the header or the vessel. In another option, the entire removable pipe section might be made of a flexible section, made for example of reinforced rubber, with flanges, made for example of plate steel, attached to each end of the flexible section. When removable pipe sections with one or more flexible sections that are part of or attached to the removable pipe section are used it is preferable, though optional, to have independent attachments between the header and the vessel. However, if independent attachments are not provided it is preferable, through optional, to use rigid removable pipe sections and leave a second set of at least three pipe sections connected to the vessel while a first set of pipe sections are removed. After the first set of pipe sections are reconnected to the ring header and the vessel, the second set of pipe sections can be removed to clean their associated annuli.

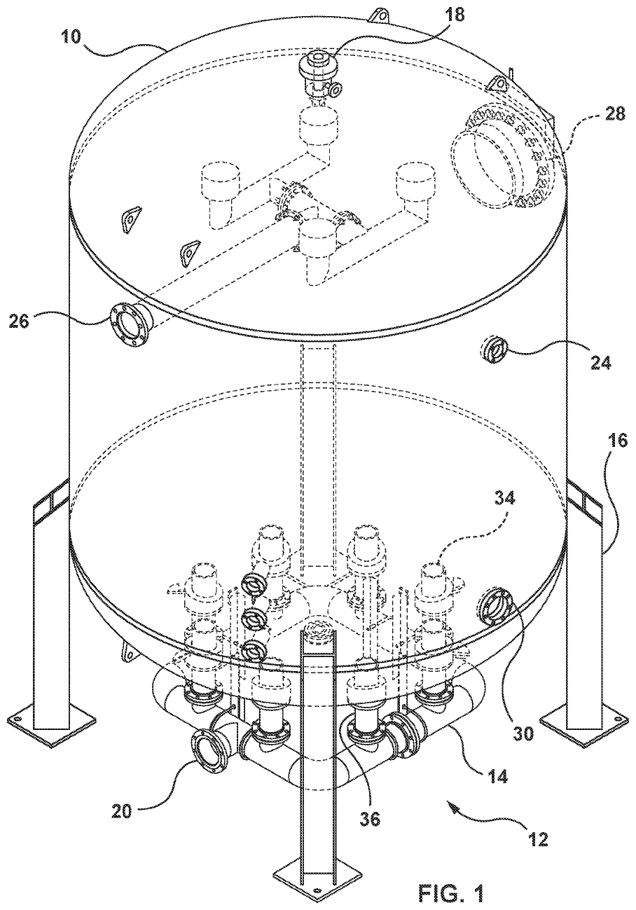

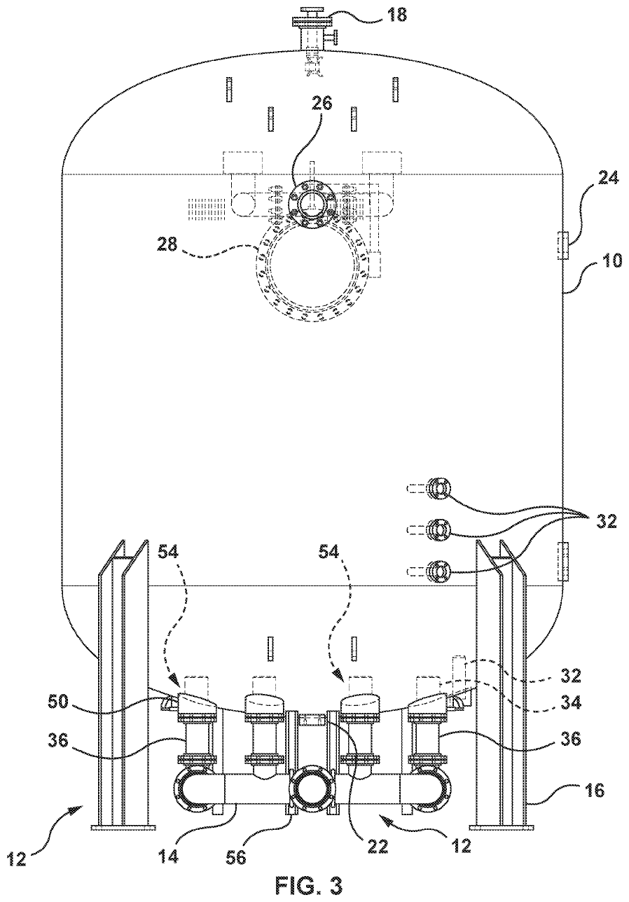

FIGS. 1-3 shows an example of a vessel 10 with an underdrain system 12. The vessel 10 in this example is a pressure vessel for holding a water treatment media such as granular activated carbon or ion exchange resin beads. The underdrain system includes a header 14 that is external to the vessel 10. In the example shown, the vessel 10 has a diameter of about 12′ (3.7 m).

The vessel 10 has a set of legs 16 to support the vessel 10 on a floor. The vessel 10 also has a wash nozzle 18 and a flanged media outlet port 22. During media changes, media is removed through the outlet port 22 while water is added through the wash nozzle 18. A media inlet port 24 is used to add new media to the vessel 10. A hatch 28 allows a person to enter the vessel 10 when necessary. A sight glass 30 is provided to allow a person to see into the vessel 10. A set of anticipatory probes 32 are provided at different elevations to allow for monitoring the condition of the media.

During use, water to be treated enters the vessel through an inlet distributor nozzle 26. The water flows through the media in the vessel, septa 34, and spools 36 to the header 14. The header 14 is in the shape of a ring with a flanged outlet port 20.

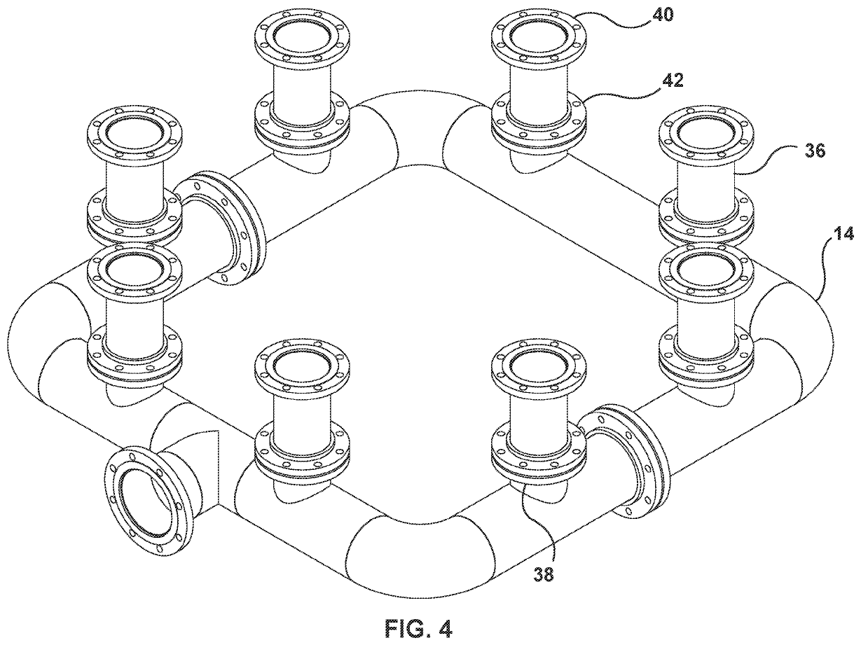

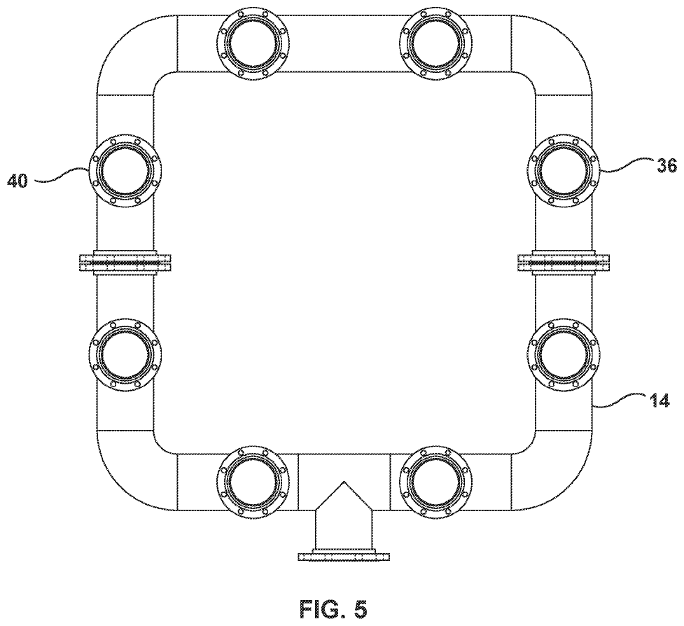

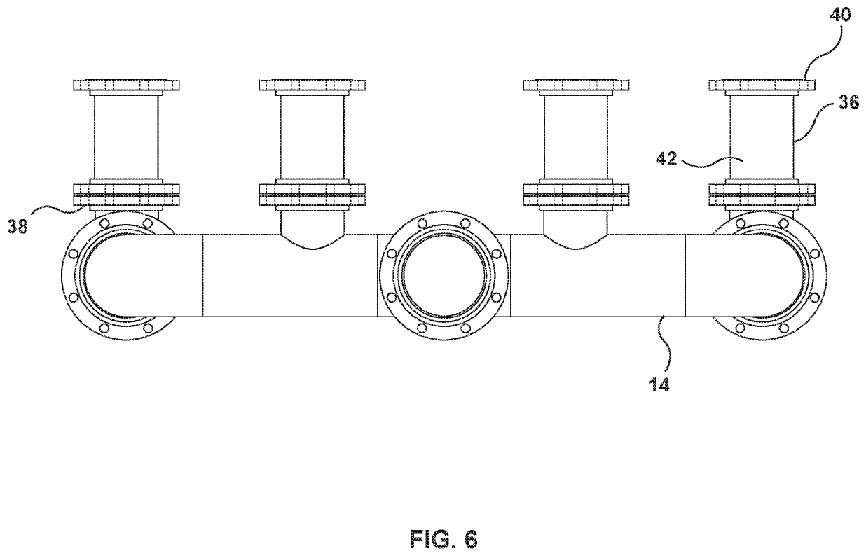

FIGS. 4-6 show the header 14 and spools 36 in greater detail. In the example shown, the header 14 is made up of sections of 8″ (20 cm) diameter pipe bolted together. The header 14 has a set of inlet flanges 38. The inlet flanges 38 are located at the top of the header 14 and oriented horizontally. Each spool 36 is a section of pipe with an upper flange 40 at the top of the spool 36 and a lower flange 42 at the bottom of the spool 36. The upper flange 40 and lower flange 42 are perpendicular to the length of the spool 36. In the example shown, the section of pipe of the spool is about 6″ (15 cm) in diameter and 12″ (30 cm) long. Bolts and nuts, not shown, attached the spools 36 to the header 14.

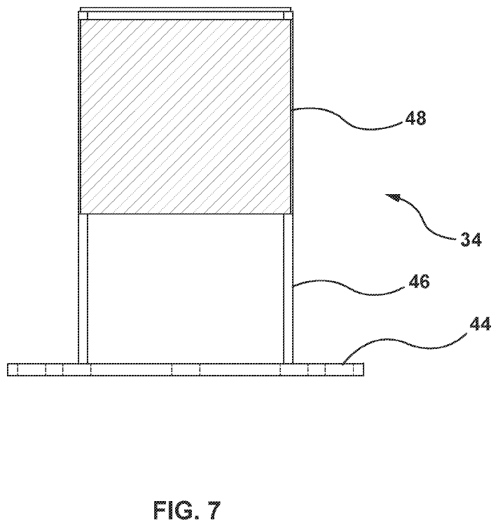

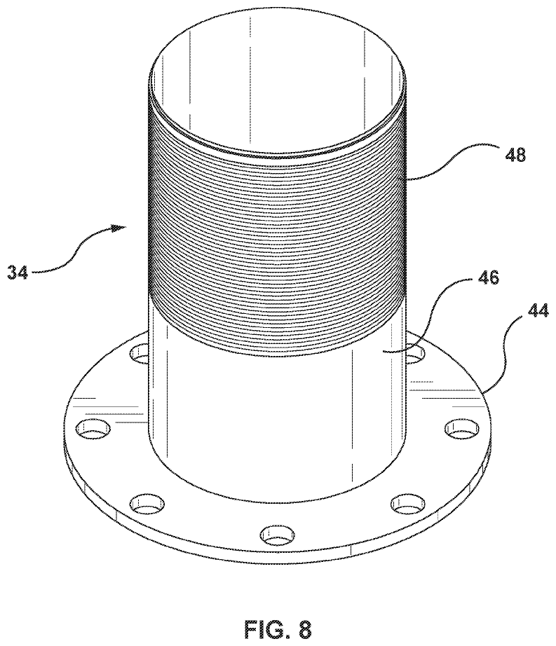

FIGS. 7-8 show a septum 34. The septum 34 has a plate flange 44 attached to a solid pipe segment 46. A screen 48, for example a well screen, is attached (i.e. welded) to the top of the solid pipe segment 46. The screen 48 may be made, for example, of stainless steel v-wire or other well screen material.

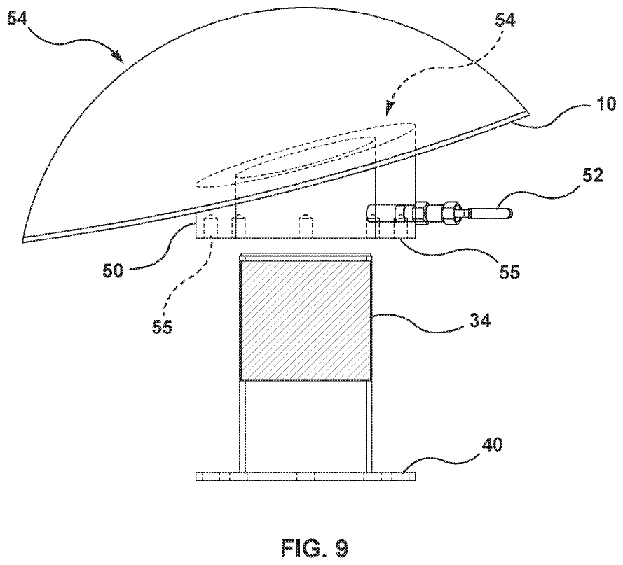

FIG. 9 shows one of a set of tangential flange pads 50 attached to the bottom of the vessel. The flange pad 50 presents a horizontal flange surface. The flange pad 50 has threaded holes 55 to accept bolts (not shown) passing through the upper flange 40 of the spool and the plate flange 44 of the septum 34. The septum 34, when inserted into the flange pad 50, extends upwards from its flange 44 into the vessel 10. Optionally, one or more ports 52 are provided through the side wall of the flange pad 50. The ports 52 may be connected to pipes and used to spray water into an annulus 54 between the flange pad 50 and the septum 34, or to withdraw a slurry from the annulus 54.

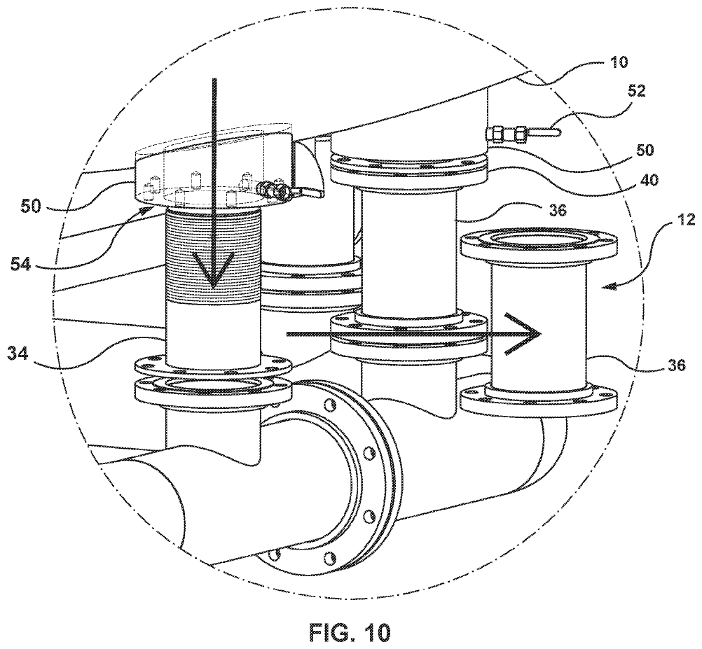

FIG. 10 shows steps in cleaning the vessel 10. A spool 36 is unbolted from the flange pad 50 and the header 14 and moved sideways away from the header 14. The septum 34, which is shorter than the spool 36, is then lowered into the space previously occupied by the spool 36. In this way, the septum 34 is removed from the vessel 10. Optionally, the septum 34 can be moved sideways to better expose the annulus 54 inside the pad flange 50. The annulus 54, or the inside of the pad flange 50 generally, can then be cleaned out. For example, media or other solids are removed from the inside of the pad flange 50. After the annulus 54 is cleaned, the septum 34 is reinstalled in the vessel 10 and the spool 36 is bolted back into place. Another spool 36 and septum 34 can then be removed. The process can be repeated until every spool 36 and septum 34 have been removed and replaced, and all of the annuli 54 are clean.

In the method described above, the header 14 remains attached to the vessel 10 even when a spool 36 is removed. Optionally, additional struts 56 may be added between the header 14 and the vessel 10 to allow more spools 36 to be removed simultaneously. However, keeping 3 or 4 spools 36 attached may be adequate to support the header 14 while other spools 36 are removed. Accordingly, eight annuli 52 can be cleaned in two to four sets if desired. Alternatively, one annulus 52 at a time may be cleaned.

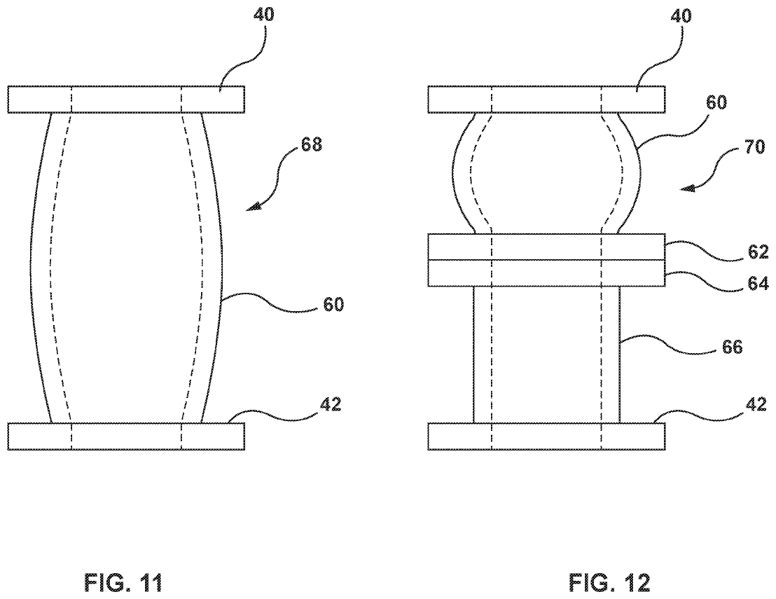

FIG. 11 shows a first alternative removable pipe section 68, which may be used in place of the spool 36 described above. The first alternative removable pipe section 68 has a flexible section 60 connected to an upper flange 40 and a lower flange 42. FIG. 12 shows a second alternative removable pipe section 70. The second alternative removable pipe section 70 has a flexible section 60 connected to an upper flange 40 and a first intermediate flange 62. The second alternative removable pipe section 70 also has a rigid pipe section 66 connected to a second intermediate flange 62 and a lower flange 42. Alternatively, variations on the second alternative removable pipe section 70 may be made with the flexible section 60 at the bottom of the second alternative removable pipe section 70 or on both the top and bottom of the second alternative removable pipe section 70.

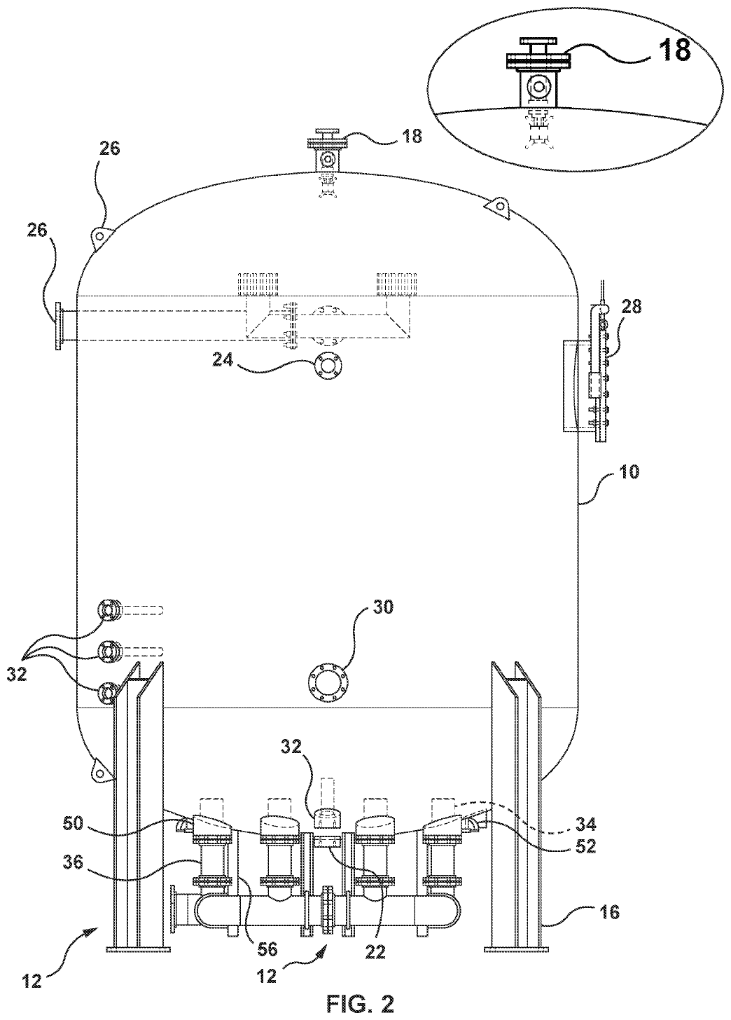

FIG. 2 shows a conventional system for cleaning the walls of the vessel. This conventional system uses a fixed nozzle 18 attached to fixed pipes to supply water to the nozzle 18. An alternative cleaning mechanism described herein is moveable and/or has a nozzle or spray that may be directed to a selected part of the vessel 10 by virtue of one or more of the following components or functionalities. The cleaning mechanism may have an elongated member that can be inserted to various vertical positions within the vessel. Optionally, the elongated member may be greater in length than the depth of the vessel, or the depth of the vessel plus 3 feet or 1 meter. A fitting at the top center of the vessel can facilitate entry of the elongated member into the vessel and/or movement of the elongated member within the vessel. The cleaning mechanism may be an accessory to the vessel 10 rather than a permanent part of it. An operator may manipulate the cleaning mechanism, for example by moving the elongated member, from above and outside of the vessel. For example, the operator may stand on scaffolding above the vessel. The operator may, for example, raise or lower the cleaning mechanism, tilt the cleaning mechanism and/or rotate the cleaning mechanism, optionally to achieve 360 degrees of rotation of a nozzle connected to the elongated member. The cleaning mechanism may be moved entirely by hand, with the aid of a machine, or by operating a machine. Optionally, a set of interchangeable spray nozzles is provided. By selecting a particular nozzle, the operator can focus or disperse spray according to a range of available patterns. The fitting is preferably capable of withstanding the friction of vertical movements and the horizontal and/or vertical thrust of the pressurized spray without damage to the vessel insertion point. After the cleaning operation is complete, the cleaning mechanism and fitting are removed and the opening in the vessel is closed, for example with a plug or cap. The vessel can then to be used for water treatment until the next cleaning operation takes place. Optionally, cleaning the vessel with the cleaning mechanism can be combined with removing the septa from the vessel. In this way, media washed from the walls of the vessel flows the bottom of the vessel and can be removed from the vessel.

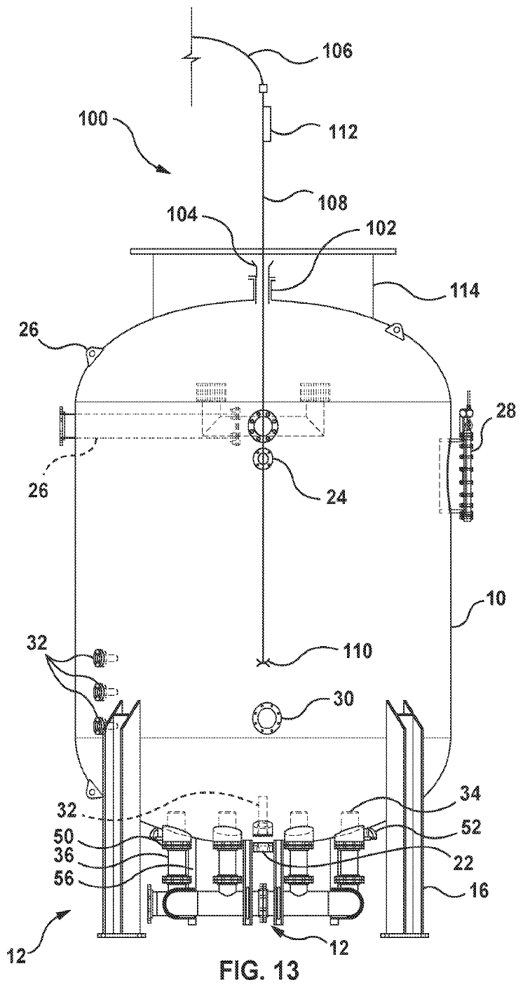

FIG. 13 shows a cleaning mechanism 100 installed in a vessel 10. A conventional spray nozzle 18 as shown in FIG. 2 has been removed from a flange 102 at the top of the vessel 10. A fitting 104 has been attached to the flange 102. The fitting 104 provides a surface for the cleaning mechanism 100 to bear against while the cleaning mechanism 100 is moved or while water is sprayed from it.

The cleaning mechanism 100 in the example shown includes a hose 106, a pipe segment 108 and a nozzle 110. Optionally, a handle 112 may be added to the pipe segment 108. The pipe segment 108 is optionally at least as long as the depth of the vessel 10. In some examples, the pipe segment 108 is at least 3 feet longer, or 1 meter longer, than the depth of the vessel 10. Alternatively, the pipe segment 108 may be replaced with a solid elongated member and the hose 106 may travel along a elongated member to the spray nozzle 110. Optionally, a set of alternative spray nozzles 110 may be provided and selectively attached to the cleaning mechanism 100.

An operator can stand on a scaffold 114 on the top of the vessel 10. A flow of water is provided through the hose 106 and the pipe segment 108 to the nozzle 110. The operator can raise or lower or rotate the cleaning mechanism 100 to direct water from the nozzle 110 against the interior surfaces of the vessel 10. Optionally, the fitting 104 may fit closely around the cleaning mechanism 100 to act as a bushing to help keep the pipe segment 108 vertically oriented. Alternatively, the fitting 104 may have sufficient clearance around the pipe segment 108 to allow the pipe segment 108 to be angled such that the nozzle 110 can be selectively moved towards or away form the walls of the vessel 10. After the vessel is cleaned, the fitting 104 and cleaning mechanism 100 are removed. A plug or cover is attached to the flange 102 so that the vessel 10 can resume being used to treat water.

Pressure vessels are increasingly being used in higher purity applications, such as PFAS removal and remediation. In those cases, the interior cleanliness of the vessel becomes more important to the quality of the effluent and better cleaning methods are desired. The ability to move, rotate and/or direct a cleaning spray enhances the ability to clean the vessel interior, for example during media changes, without a confined space entry. Cleaning the vessel better leads to better quality effluent after the media change. Relative to a conventional fixed spray nozzle, less water and/or cleaning chemicals are required to achieve a selected level of cleanliness.

1-17. (canceled)

18. An apparatus for cleaning a pressure vessel comprising,
an elongated member;
a spray nozzle attached to a first end of the elongate nozzle; and,
a conduit integrated with or attached to the elongated member to carry a liquid to the spray nozzle.

19. The apparatus of claim 18 wherein the elongated member is a pipe and the conduit is provided by the interior of the pipe.

20. The apparatus of claim 18 comprising a set of alternative spray nozzles that may be selectively attached to the elongated member and put in liquid communication with the conduit.

21. The apparatus of claim 18 wherein manipulation of the elongated member moves the spray nozzle one or more of horizontally, vertically and rotationally within the vessel.

22. The apparatus of claim 18 wherein the elongated member is at least as long as the height of the vessel.

23. The apparatus of claim 22 wherein the elongated member is at least 3 feet or 1 meter longer than the height of the vessel.

24. The apparatus of claim 18 wherein comprising a fitting that may be selectively attached to an opening of the vessel, wherein the elongated member passes through the fitting.

25. The apparatus of claim 24 wherein the fitting is adapted to be attached to a flange at the top of the vessel.

26. The apparatus of claim 24 wherein the fitting has a bore having an inside diameter adapted to act as a bushing for the elongated member.

27. The apparatus of claim 18 further comprising a plug or cover that may be selectively attached to an opening in the vessel.

28. The apparatus of claim 18 further comprising a handle or machine attached to a second end of the elongated member.

29. The apparatus of claim 18 in combination with an underdrain system comprising,
an external header;
a plurality of removable pipe sections, each having an upper end and a lower end; and,
a plurality of septa, each septum corresponding to one of the removable pipe sections,
wherein the bottom of each movable pipe section is attached to the external header, the top of each removable pipe section is attached to the bottom of the vessel, and the septa extend upwards into the tank.

30. A method of cleaning a pressure vessel comprising the steps of,
exposing an opening at the top of the vessel;
inserting an elongated mechanism having a conduit in communication with a spray nozzle into the pressure vessel such that the spray nozzle is inside the vessel;
flowing water through the conduit to the spray nozzle; and,
moving the elongated mechanism to change the position of the spray nozzle in the vessel.

31. The method of claim 30 wherein the elongated mechanism is moved while flowing water through the conduit.

32. The method of claim 30 comprising flowing water through the conduit while the spray nozzle is in one position, stopping the flow of water, moving the spray nozzle to another position and restarting the flow of water.

33. The method of claim 30 comprising placing a fitting over the elongated mechanism and attaching the fitting to the vessel.

34. The method of claim 30 in combination with a method of cleaning a media pressure vessel comprising the steps of,
removing one or more pipe sections from between an external header and the vessel while the header remains otherwise attached to the vessel; and,
removing one or more septa associated with the one or more pipe sections from the vessel.
